(19) United States
(12) Patent Application Publication
(10) Pub. No.: US 2023/0137373 A1
(43) Pub. Date: May 4, 2023

(54) PARTIAL DEHYDROGENATION OF ORGANIC LIQUIDS

(71) Applicant: ARKEMA FRANCE, Colombes (FR)

(72) Inventors: Jérôme BLANC, PIERRE-BENITE CEDEX (FR); Bernard MONGUILLON, COLOMBES CEDEX (FR)

(21) Appl. No.: 17/905,424

(22) PCT Filed: Mar. 1, 2021
(86) PCT No.: PCT/FR2021/050344

§ 371 Date: Sep. 1, 2022

(30) Foreign Application Priority Data
Mar. 3, 2020 (FR) 2002116

(51) Int. Cl. C01B 3/00; C01B 3/22

(52) U.S. Cl. CPC C01B 3/0015; C01B 3/22; C01B 2203/0277; C01B 2203/1252

(57) ABSTRACT

The present invention concerns a process for producing hydrogen by partial dehydrogenation of an organic liquid, said process comprising a step of supplying at least one organic liquid having a Degree of Hydrogenation DHplus, a step of partially dehydrogenating said liquid, a step of recovering firstly gaseous hydrogen and secondly said organic liquid having a Degree of Hydrogenation DHminus, and wherein the ratio DHplus/DHminus is between 1 and 25, endpoints excluded.

The invention likewise concerns a hydrogenation/dehydrogenation cycle comprising at least the process of the invention for producing hydrogen by partial dehydrogenation of an organic liquid and at least one hydrogenation reaction of said organic liquid.

The present invention relates to hydrogen transport using liquid organic compounds, especially liquid organic compounds bearing aromatic rings, that can be hydrogenated in order to “transport” hydrogen molecules, then dehydrogenated in order to release said hydrogen molecules.

The use of aromatic molecules has already been studied in the hydrogen transport and storage field (referred to as “Liquid Organic Hydrogen Carrier” technology and also known by the acronym “LOHC”).

The principle consists first in fixing the hydrogen on a carrier molecule. This is the hydrogenation step. Said carrier molecule is preferably liquid at ambient temperature. This hydrogenated carrier molecule can readily be transported and handled, and especially more easily and more safely than hydrogen in the gaseous or liquid state. The principle then consists in releasing the hydrogen present on the carrier molecule, advantageously close to and preferably in immediate proximity to the site of consumption. This is the dehydrogenation step.

Among the molecules considered, the use of benzyltoluene and/or dibenzyltoluene is an option of interest which has been studied and published in the scientific literature and in the patent literature.

Patent EP2925669 accordingly describes the use of a mixture comprising isomers of benzyltoluene and/or dibenzyltoluene in catalytic processes for fixing and releasing hydrogen in the mixture or from the mixture. The works of A. Bulgarin et al. (Int. Journal of Hydrogen Energy, 45(1), (2020), 712-720) refer to the dehydrogenation of perhydrodibenzyltoluene in the presence of a platinum-on-alumina catalyst at a temperature of 280° C. to 300° C.

As well as the immediate performance of the hydrogenation and dehydrogenation steps, the sequencing of the cycles and the maintaining of the performance levels (hydrogen fixation/release yield) is a key parameter as regards the economic aspect of this technology. Moreover, in the case of dibenzyltoluene (DBT), the cycle is based on the total hydrogenation to perhydrodibenzyltoluene (H18-DBT), but the total dehydrogenation for releasing 18 hydrogen atoms is performed under severe operating conditions (280° C. to 300° C.), which are near to the stability limit for the DBT (330° C. to 350° C.). This not only has the disadvantage of entailing a progressive decrease in performance over the cycles, but also impacts the long-term operational yield, to say nothing of the purity of the hydrogen produced, which degrades over the cycles because of the byproducts formed by the carrier molecule.

The solutions proposed to date, then, while promising, are fairly unsatisfactory. The reason is that the hydrogen-bearing liquids as presently proposed undergo significant degradations over the hydrogenation/dehydrogenation cycles, and must therefore be replaced relatively often.

There remains today a need for industrially practicable processes capable of fixing and releasing hydrogen, said process being carried out under conditions less severe than those presently known, in order to hold out the promise of large-scale development of this technology, by favoring a large number of hydrogen fixation/release cycles, while maintaining the performance levels of the carrier liquid and so providing a technology compatible economically with the development of the transport, production and use of hydrogen on a large scale, especially in hydrogen engines for transport, as for example automobiles, trains and boats, to state only the principal uses envisaged.

The inventors have now found that it is possible to carry out a large number of hydrogen fixation/release cycles (hydrogenation/dehydrogenation) using an organic carrier liquid, comprising at least one aromatic ring system, by limiting the rate of degradation of said carrier liquid over the cycles, and so enabling more economically efficient transport and supply of hydrogen, especially in terms of the lifetime of the carrier liquid and of hydrogen purity at the end of the operations of dehydrogenating said carrier liquid.

Yet further advantages will become apparent in light of the following description of the present invention.

In a first aspect, then, the present invention concerns a process for producing hydrogen by partial dehydrogenation of an organic liquid, said process comprising:
a step of supplying at least one organic liquid having a Degree of Hydrogenation DHₚₗᵤₛ,
a step of partially dehydrogenating said liquid,
a step of recovering firstly gaseous hydrogen and secondly said organic liquid having a Degree of Hydrogenation DHₘᵢₙᵤₛ,
the ratio DHₚₗᵤₛ/DHₘᵢₙᵤₛ being between 1 and 25, endpoints excluded, preferably between 1.1 and 20, endpoints included.

The “Degree of Hydrogenation” refers to the numerical fraction of double bonds in the organic liquid that are hydrogenated, i.e., saturated with hydrogen atoms, relative to the total number of double bonds that can be hydrogenated. For example, the DiBenzylToluene (DBT) molecule possesses 3 aromatic rings and potentially 9 double bonds that can be hydrogenated. DBT has a Degree of Hydrogenation of zero (0), and the fully hydrogenated DBT molecule has a Degree of Hydrogenation of one (1).

A ratio DHₚₗᵤₛ/DHₘᵢₙᵤₛ of 1 (not included in the present invention) indicates the absence of hydrogen release during the dehydrogenation. A ratio DHₚₗᵤₛ/DHₘᵢₙᵤₛ of 25 (not included in the present invention) corresponds to a residual Degree of Hydrogenation DHₘᵢₙᵤₛ of the organic liquid at the end of the dehydrogenation step of 4%.

“Partial dehydrogenation” means that rather than a total dehydrogenation of the organic liquid, only a partial dehydrogenation is carried out, leading to an organic liquid with a Degree of Hydrogenation DHₘᵢₙᵤₛ of strictly greater than 0.

The “partial” reaction described above for dehydrogenation may be carried out as a conventional dehydrogenation reaction, but without aiming to attain a 100% yield in said dehydrogenation reaction, i.e., without aiming to supply all of the hydrogen molecules transported by the organic liquid.

Various means may be used for avoiding attaining a 100% yield (corresponding to a degree of dehydrogenation of 100% of the hydrogen atoms that can be dehydrogenated). These means, which are well-known to those skilled in the art, include—without limitation—one or more of the following means, individually or in a combination of two or more thereof:
blocking of the reaction before a 100% dehydrogenation yield is obtained,
reaction temperature lower than the temperature commonly used for the dehydrogenation reaction,
reaction pressure lower than the pressure commonly used for the dehydrogenation reaction,
low-selectivity dehydrogenation catalyst,
and any other means for regulating the dehydrogenation reaction kinetics.

Controlling the dehydrogenation conditions thus allows this reaction to be conducted partially, in contrast to the teaching given in the prior art to those skilled in the art. By operating a partial dehydrogenation step, i.e., by not conducting the reaction until all of the hydrogen atoms transported are released, it has surprisingly been found that the energy expenditure is lower, while the quantity of hydrogen molecules transported is entirely satisfactory.

The reason is that one of the problems associated with the cycles of hydrogenation and dehydrogenation of the organic liquids which can be used in hydrogen transport is their stability when heated to temperatures close to their boiling point. It has been observed that said organic liquids can undergo modification via phenomena of dimerization or of rearrangement/reorganization, giving rise to the formation of diverse chemical species. These modifications produce a loss of purity of the initial organic liquid and a loss of yield over time. This loss is linked primarily to the inherent modifications to the characteristics of the organic liquid, including, as a nonlimiting example, a modification in the viscosity, which may be detrimental to the handling, storage and usage of the organic liquid useful in the transport of hydrogen.

The process according to the present invention hence enables an improvement in the stability of the organic liquid subject to the hydrogenation/dehydrogenation cycles and consequently a reduced generation of degradation products of said organic liquid, and especially of light degradation products (which thus are volatile and so liable to contaminate the hydrogen released), and/or of heavy degradation products (which thus are liable to increase the viscosity of the organic liquid and hence impair the subsequent cycles).

Yet further advantages result from the system of the present invention, and especially, when the temperature of hydrogenation or of dehydrogenation is lower than that encountered in the prior art for equivalent reactions carried out up to 100% yields, the thermal degradation of the carrier molecule is greatly reduced as a result, and so the lifetime of said carrier molecule is improved. An increased carrier molecule lifetime also allows a substantial increase in the number of cycles.

The degree of advancement of the dehydrogenation reaction may be readily controlled by any means known to those skilled in the art, as for example according to the indications furnished by K. Müller et al. (“Experimental assessment of the degree of hydrogen loading for the dibenzyl toluene based LOHC system”, International Journal of Hydrogen Energy, 41, (2016), 22097-22103), and especially by Raman spectrometry, by refractive index measurement, by density measurement, or else by measuring the quantity of hydrogen produced, etc.

In the process of the present invention, the organic liquid may be of any kind well-known to those skilled in the art that is capable of transporting hydrogen atoms, i.e., is able to be at least partially hydrogenated and/or at least partially dehydrogenated. The organic liquid that can be used within the process according to the present invention may also be a mixture of two or more organic liquids, which may have identical or different Degrees of Hydrogenation.

The organic liquid that can be used within the present invention usually and advantageously possesses at least one aromatic ring, which is optionally partially dehydrogenated.

More particularly, the organic liquid that can be used within the process of the present invention conforms to the general formula (1):

(A−X)ₙ−B (1)

in which:
A and B, which are identical or different, represent, independently of one another, an aromatic ring optionally partially dehydrogenated and optionally substituted by one or more saturated or partially or completely unsaturated hydrocarbon radicals comprising from 1 to 20 carbon atoms, preferably from 1 to 18 carbon atoms, more preferably from 1 to 12 carbon atoms, better still from 1 to 10 carbon atoms, even better still from 1 to 6 carbon atoms, typically from 1 to 3 carbon atoms,
X represents a spacer group, selected from a single bond, an oxygen atom, a sulfur atom, the divalent radical —(CRR′)ₘ—, the divalent radical >C═CRR′, and the divalent radical —NR″—
R and R′, which are identical or different, are selected, independently of one another, from hydrogen and a saturated or partially or completely unsaturated hydrocarbon radical comprising from 1 to 6 carbon atoms, preferably from 1 to 3 carbon atoms,
R″ represents a saturated or partially or completely unsaturated hydrocarbon radical comprising from 1 to 6 carbon atoms, preferably from 1 to 3 carbon atoms,
m represents an integer of between 1 and 4, endpoints included, and
n can be equal to 0 or represents an integer equal to 1, 2 or 3, preferably equal to 1 or 2, with the restriction that, when n is equal to 0, B is substituted by one or more hydrocarbon radicals, as defined above.

“Aromatic ring” refers to monocyclic aromatic hydrocarbon structures and polycyclic aromatic hydrocarbon structures, comprising from 6 to 20 carbon atoms. “Polycyclic” refers to fused or condensed cyclic structures.

When n is equal to 0, the organic liquid of formula (1) defined above forms part of the class of the alkylbenzenes, which are optionally partially dehydrogenated. When n is equal to 2 or 3, the groups (A-X) may be identical or different.

According to one preferred embodiment of the present invention, in the organic liquid of general formula (1), n is other than 0 and B is substituted by a hydrocarbon radical. Preferably again, said hydrocarbon radical is an alkyl radical comprising from 1 to 6 carbon atoms, preferably from 1 to 4 carbon atoms, and preferably the alkyl radical is the methyl radical.

According to another preferred embodiment of the present invention, in the organic liquid of general formula (1), n is 0 and the organic liquid of formula (1) is generally selected from linear alkylbenzenes, which are optionally partially dehydrogenated, and branched alkylbenzenes, which are optionally partially dehydrogenated, such as, for example and without limitation, alkylbenzenes, and homologs which are partially dehydrogenated, in which the alkyl moiety comprises from 10 to 20 carbon atoms. Such alkylbenzenes include, again without limitation, decylbenzene, dodecylbenzene, octadecylbenzene, and their at least partially dehydrogenated homologs, to mention only a few of them.

As indicated earlier, the organic liquids conforming to the general formula (1) above can be used, alone or as mixtures of two or more of them in any proportions. According to one preferred embodiment of the invention, the organic liquid employed in the process of the present invention may contain one compound bearing at least one aromatic radical, which is optionally partially dehydrogenated, or a mixture of two or more compounds bearing at least one aromatic radical, which is optionally partially dehydrogenated. According to one especially preferred embodiment, the organic liquid employed in the process of the invention is liquid at ambient temperature and ambient pressure.

According to yet another preferred embodiment of the present invention, the organic liquid is selected from benzyltoluene (BT), dibenzyltoluene (DBT), their partially dehydrogenated homologs, and mixtures thereof in any proportions.

In an especially preferred embodiment, the organic liquid is selected from the organic liquids sold by Arkema under the trade names of the Jarytherm® range.

Other organic liquids, and homologs which are at least partially dehydrogenated, suitable for the requirements of the present invention are, for example, those sold by Eastman, especially under the trade name Marlotherm®.

Mention may be made, as yet other examples of organic liquids suitable for the requirements of the present invention, of the following:
diphenylethane (DPE) and its isomers, especially 1,1-DPE (CAS 612-00-0), 1,2-DPE (CAS 103-29-7) and their mixtures (in particular CAS 38888-98-1); such organic liquids are available commercially or described in the literature, for example in the document EP 0 098 677,
ditolyl ether (DT) and its isomers, especially those corresponding to the numbers CAS 4731-34-4 and CAS 28299-41-4 and their mixtures, these being in particular commercially available from Lanxess, under the trade name DiphylDT,
phenylxylylethane (PXE) and its isomers, especially those corresponding to the numbers CAS 6196-95-8 and CAS 76090-67-0 and their mixtures, in particular commercially available from Changzhou Winschem, under the trade name PXE Oil,
1,2,3,4-tetrahydro-(1-phenylethyl)naphthalene (CAS 63674-30-6), this product being commercially available in particular from Dow under the reference Dowtherm™ RP,
diisopropylnaphthalene (CAS 38640-62-9), available in particular from Indus Chemie Ltd, under the trade name KMC 113,
monoisopropylbiphenyl and its isomers (CAS 25640-78-2), in particular available under the trade name Wemcol, and
phenylethylphenylethane (PEPE) and its isomers (CAS 6196-94-7), in particular available from Changzhou Winschem or Yantai Jinzheng,
and their homologs which are at least partially dehydrogenated,
and mixtures of two or more of them, in any proportions, to mention only the main organic liquids known and usable in the context of the present invention.

The organic liquid which can be used in the context of the present invention can in addition contain one or more additives well-known to those skilled in the art, and selected, for example and without limitation, from antioxidants, passivators, pour point depressants, decomposition inhibitors and their mixtures. An organic liquid especially preferred for the process of the present invention comprises at least one antioxidant.

The antioxidants that may advantageously be used in the organic liquid include, as nonlimiting examples, phenolic antioxidants, such as, for example, dibutylhydroxytoluene, butylhydroxyanisole, tocopherols, and also the acetates of these phenolic antioxidants. Further instances are the antioxidants of amine type, such as, for example, phenyl-α-naphthylamine, of diamine type, as for example N,N′-di(2-naphthyl)-para-phenylenediamine, but also ascorbic acid and its salts, esters of ascorbic acid, alone or as mixtures of two or more thereof or with other components, as for example green tea extracts and coffee extracts.

As a general rule, the organic liquid employed in the partial dehydrogenation process according to the invention is a fully hydrogenated or at least partially dehydrogenated organic liquid. According to one embodiment of the invention, the organic liquid employed in the partial dehydrogenation step has a Degree of Hydrogenation DHₚₗᵤₛ of not more than 1. The Degree of Hydrogenation DHₚₗᵤₛ is strictly greater than 0, preferably not less than 0.1, more preferably not less than 0.2, better still not less than 0.4, especially preferably not less than 0.6, advantageously greater than 0.8.

In one especially preferred embodiment of the process according to the present invention, the organic liquid employed in the dehydrogenation step has a Degree of Hydrogenation DHₚₗᵤₛ conforming to the following inequation:

0.6≤DHₚₗᵤₛ<1.

At the end of the step of partial dehydrogenation of the organic liquid, it is therefore partially dehydrogenated, and advantageously is virtually but not totally dehydrogenated. According to one embodiment of the invention, the organic liquid at the end of the partial dehydrogenation reaction has a Degree of Hydrogenation DHₘᵢₙᵤₛ of strictly less than 1, preferably not more than 0.8, more preferably not more than 0.6, better still not more than 0.4.

In one especially preferred embodiment of the process according to the present invention, the organic liquid at the end of the partial dehydrogenation step has a Degree of Hydrogenation DHₘᵢₙᵤₛ conforming to the following inequation:

0<DHₘᵢₙᵤₛ≤0.6.

As indicated earlier, the ratio DHₚₗᵤₛ/DHₘᵢₙᵤₛ is other than 1 (no dehydrogenation reaction) and therefore DHₚₗᵤₛ cannot equal DHₘᵢₙᵤₛ.

The dehydrogenation reaction may be performed by any method known to those skilled in the art, with the restriction that it is not conducted so as to dehydrogenate the entirety of the organic liquid employed.

The operating conditions that may be employed include the following, as nonlimiting examples:
a reaction temperature of generally between 150° C. and 350° C., preferably between 180° C. and 350° C., advantageously between 200° C. and 350° C., better still between 250° C. and 350° C., preferably between 250° C. and 330° C., and more preferably between 280° C. and 330° C. and totally preferably between 280° C. and 320° C.,
a reaction pressure of generally between 0.01 Pa and 3 Pa, and preferably between 0.1 Pa and 2 Pa, the reaction pressure preferably being atmospheric pressure.

The reaction is usually and advantageously conducted in the presence of at least one dehydrogenation catalyst well-known to those skilled in the art. The catalysts which can be used for said partial dehydrogenation reaction include, as nonlimiting examples, heterogeneous catalysts containing at least one metal on a support. Said metal is selected from the metals of groups 3 to 12 of the IUPAC periodic table of the elements, which is to say from the transition metals in said periodic table. In one preferred embodiment, the metal is selected from the metals of groups 5 to 11, more preferably of groups 5 to 10 of the IUPAC periodic table of the elements.

The metals of these catalysts are usually selected from iron, cobalt, copper, titanium, molybdenum, manganese, nickel, platinum and palladium and mixtures thereof. The metals are preferably selected from copper, molybdenum, platinum and palladium and mixtures of two or more of these in any proportions.

The support of the catalyst may be of any type well-known to those skilled in the art and is advantageously selected from porous supports, more advantageously from porous refractory supports. Nonlimiting examples of supports include alumina, silica, zirconia, magnesia, beryllium oxide, chromium oxide, titanium oxide, thorium oxide, ceramic, carbon such as carbon black, graphite and activated carbon, and also combinations thereof. The specific and preferred examples of supports which can be used in the process of the present invention include amorphous aluminosilicates, crystalline aluminosilicates (zeolites) and supports based on silica-titanium oxide.

The process according to the present invention comprising a step of partial dehydrogenation of an organic liquid is accomplished advantageously in one or more cycles, more advantageously in a plurality of cycles, of hydrogenation/dehydrogenation, thereby enabling the storage and transport of hydrogen in said hydrogenated organic liquid.

The hydrogenation reaction may be performed by any method well-known to those skilled in the art on an organic liquid as defined above, advantageously an organic liquid comprising at least one aromatic ring and preferably an organic liquid conforming to the general formula (1) as defined earlier.

The hydrogenation reaction is generally conducted at a temperature of between 120° C. and 200° C., and preferably between 130° C. and 180° C. and more preferably from 140° C. to 160° C. The pressure employed for this reaction is generally between 0.1 MPa and 5 MPa, and preferably between 0.5 MPa and 4 MPa, and more preferably between 1 MPa and 3 MPa.

The hydrogenation reaction is usually conducted in the presence of a catalyst, and more particularly a hydrogenation catalyst well-known to those skilled in the art, and advantageously selected from, as nonlimiting examples, heterogeneous catalysts containing metals on a support. Said metal is selected from the metals of groups 3 to 12 of the IUPAC periodic table of the elements, which is to say from the transition metals in said periodic table. In one preferred embodiment, the metal is selected from the metals of groups 5 to 11, more preferably of groups 5 to 10 of the IUPAC periodic table of the elements.

The metals of these hydrogenation catalysts are usually selected from iron, cobalt, copper, titanium, molybdenum, manganese, nickel, platinum and palladium and mixtures thereof. The metals are preferably selected from copper, molybdenum, platinum and palladium and mixtures of two or more of these in any proportions.

The support of the catalyst may be of any type well-known to those skilled in the art and is advantageously selected from porous supports, more advantageously from porous refractory supports. Nonlimiting examples of supports include alumina, silica, zirconia, magnesia, beryllium oxide, chromium oxide, titanium oxide, thorium oxide, ceramic, carbon such as carbon black, graphite and activated carbon, and also combinations thereof. The specific and preferred examples of supports which can be used in the process of the present invention include amorphous aluminosilicates, crystalline aluminosilicates (zeolites) and supports based on silica-titanium oxide.

According to one preferred embodiment, the hydrogenation reaction is implemented on an organic liquid which is fully or partially dehydrogenated, preferably partially dehydrogenated, more particularly when said organic liquid has come from the partial dehydrogenation process as has just been defined above.

The hydrogenation reaction may be partial or total, and preferably the hydrogenation reaction is total, meaning that the entirety of the double bonds in the carrier liquid that can be hydrogenated are totally hydrogenated.

According to another aspect, the present invention concerns a hydrogenation/dehydrogenation cycle comprising at least the process as has just been defined for producing hydrogen by partial dehydrogenation of an organic liquid and at least one hydrogenation reaction of said organic liquid.

In the cycle of the present invention, it should be appreciated that the hydrogenation reaction of the organic liquid (carrier molecule which is to store the hydrogen) may be operated a single time or repeated two or more times. Accordingly there may be a first, partial or total hydrogenation, then one or more further partial or total hydrogenations directly on the organic liquid from the immediately preceding step.

Similarly, in the cycle of the present invention, it should be appreciated that the process of partial dehydrogenation of the organic liquid (carrier molecule which is to release the hydrogen) may be operated a single time or repeated two or more times, with the proviso that at least one, advantageously two, more advantageously a plurality, and more preferably all of the dehydrogenation processes are conducted partially, i.e., without totally dehydrogenating the organic liquid, as indicated earlier.

In the cycle according to the invention, consideration may therefore be given to operating one or more dehydrogenation processes including at least one which is a process of partial dehydrogenation according to the invention, prior to and/or consecutively with one or more hydrogenation steps on an organic liquid capable of storing, transporting and releasing hydrogen.

The one or more dehydrogenation and hydrogenation reactions may be conducted with identical or different dehydrogenation and hydrogenation yields. Accordingly it is possible to conduct at least one dehydrogenation reaction partially (including at least one partially), then another to a degree of dehydrogenation which is higher or lower or the same. Similarly it is possible to conduct at least one hydrogenation reaction partially or totally, then another to a degree of dehydrogenation which is higher or lower or the same.

It has been possible to observe that the cycle of the present invention enables the storage in a form liquid at ambient temperature and pressure, the transport in a form liquid at ambient temperature and pressure, and the release of hydrogen safely and with entirely acceptable economic yields, more particularly owing to a limited and controlled aging (degradation) of the organic liquid, i.e., to an organic liquid of enhanced stability, by virtue of the step of partial dehydrogenation in the process according to the present invention.

Enhancing the stability of the organic liquid engenders a reduced generation of light degradation products (which are thus volatile and so capable of contaminating the hydrogen released), and of heavy degradation products, which are thus capable of increasing the viscosity of the product and impairing the subsequent cycles.

The cycle of the present invention thus represents an efficient and profitable system of hydrogen transport, which is safe as well since it avoids the transport of hydrogen in gaseous form. The cycle of the present invention enables the “transport” of molecules of hydrogen, i.e., the fixing of the hydrogen to an organic liquid and then the release of the hydrogen fixed on said organic liquid, as already proposed in the prior art, with the difference that at least one dehydrogenation step in the cycle is conducted not totally but only partially, as has been described above.

The invention is now illustrated by means of the following examples, which are given as embodiments of the invention, but without imposing any limitation on the scope of protection as defined in the appended claims.

### EXAMPLES

### Example 1

The examples which follow correspond to partial dehydrogenation tests carried out on an organic liquid, namely DiBenzylToluene (DBT), from Arkema.

A 100 mL three-neck flask fitted with a condenser is charged with 0.1 mol of H18-DBT and 0.15 mol % of a platinum-on-alumina (0.5% by weight) catalyst. The assembly is purged by nitrogen flushing to remove any trace of ambient air from the reactor. After calibration of the thermal conductivity analyzer (FTC200, version 1.05, Wagner) at ambient temperature, the mixture is heated to 300° C. using a heating jacket. The hydrogen released is collected by virtue of the constant nitrogen stream and the amount of hydrogen produced is monitored continuously using the thermal conductivity analyzer (FTC200, version 1.05, Wagner).

The number of moles of hydrogen released can be correlated with the Degree of Hydrogenation DHₘᵢₙᵤₛ at the end of the dehydrogenation step. For each test, a determination is made of the molar percentage of DBT degraded (number of moles remaining/number of moles introduced).

The results are presented in table 1 below:

TABLE 1

| DHₘᵢₙᵤₛ | % degradation DBT |
|---|---|
| 0 | 5 |
| 0.15 | 1 |
| 0.33 | 0.01 |
| 0.67 | 0.008 |
| 1 | 0.002 |

The results above show clearly that total dehydrogenation (DHₘᵢₙᵤₛ=0) leads to 5% degradation of the DBT. With a partial dehydrogenation step (DHₘᵢₙᵤₛ>0), the degradation of the DBT is considerably diminished, becoming negligible or virtually negligible for a DHₘᵢₙᵤₛ greater than 0.15.

It is possible accordingly to envisage, for example, a succession of partial dehydrogenation reactions, each leading to a release of hydrogen and a remaining fraction of DBT (undegraded DBT) which is low, even with a DHₘᵢₙᵤₛ of 0.33 (remaining fraction of DBT of 0.99%). After n partial dehydrogenation reactions, and therefore n hydrogen release reactions, the degradation of the DBT will be contained within entirely reasonable limits, with degradation equivalent to 0.99n at the end of the n^{th} dehydrogenation reaction.

### Example 2

This example is carried out starting from H12-BT, a hydrogenated form of benzyltoluene (BT) prepared by Arkema.

A 100 mL three-neck flask fitted with a condenser is charged with 0.1 mol of H12-BT, characterized by a DHₚₗᵤₛ=0.95, and 0.15 mol % of a platinum-on-alumina (0.5% by weight) catalyst. The assembly is purged by nitrogen flushing to remove any trace of ambient air from the reactor. The mixture is heated to variable temperatures using a heating jacket. The hydrogen released is collected by virtue of the constant nitrogen stream and the amount of hydrogen produced is monitored continuously using the thermal conductivity analyzer (FTC200, version 1.05, Wagner).

The number of moles of hydrogen released can be correlated with the Degree of Hydrogenation DHₘᵢₙᵤₛ at the end of the dehydrogenation step. For each test, a determination is made of the molar percentage of BT degraded (number of moles remaining/number of moles introduced in the form of H12-BT).

The results are presented in table 2 below:

TABLE 2

| | Dehydrogenation | | | % |
|---|---|---|---|---|
| | reaction | | | degradation |
| Test | temperature | DHₘᵢₙᵤₛ | DHₚₗᵤₛ/DHₘᵢₙᵤₛ | BT |
| 2-01 | 285° C. | 0.02 | 47.5 | 2 |
| 2-02 | 270° C. | 0.05 | 19.0 | 0.5 |
| 2-03 | 250° C. | 0.23 | 4.1 | 0.3 |

### Example 3

This example is carried out starting from H12-BT, a hydrogenated form of benzyltoluene (BT) prepared by Arkema, and describes the change in the carrier molecule (termed LOHC) over 200 successive hydrogenation/dehydrogenation cycles. Each dehydrogenation step is carried out according to the procedure described in example 2, and each hydrogenation step is carried out in a stainless steel batch autoclave with a volume of 300 mL. The hydrogenated or partially hydrogenated form of the LOHC molecule is introduced simultaneously with the Ru/Al₂O₃ catalyst in a molar ratio of 400:1. The reaction is conducted at 150° C. and the hydrogen pressure applied is 50 bar (5 MPa) and the reaction time is one hour.

For each test, a determination is made of the molar percentage of residual BT (number of moles remaining/number of moles introduced in the form of H12-BT) at the end of the 200 cycles. “Residual BT” means any molecule which is neither BT nor partially or totally hydrogenated BT. The residual BT can be easily analyzed and quantified (in moles) by any appropriate analytical means, and in particular by GC-MS analysis. More specifically, in the context of the present invention, the degradation is measured by fluid analysis at the end of the cycles by coupled gas chromatography/mass spectrometry (GC/MS), in electron ionization and quadrupole analyzer mode.

Test 3.01 corresponds to a succession of total hydrogenation and dehydrogenation reactions, executed at 280° C. Test 3.02 corresponds to a succession of partial hydrogenation and dehydrogenation reactions executed at 250° C.

The results are presented in table 3 below. The values of DHₚₗᵤₛ and DHₘᵢₙᵤₛ presented in table 3 are the average values calculated from the values of DHₚₗᵤₛ and DHₘᵢₙᵤₛ in each cycle.

TABLE 3

| | Dehydrogenation | | | | % residual BT |
|---|---|---|---|---|---|
| | reaction | Number of | DHₚₗᵤₛ before | DHₘᵢₙᵤₛ after | at the end of 200 |
| Test | temperature | cycles | dehydrogenation | dehydrogenation | cycles performed |
| 3-01 | 280° C. | 200 | 1 | 0 | 65 |
| 3-02 | 250° C. | 200 | 0.95 | 0.15 | 98.5 |

These results show that when the cycles are conducted under conditions where the hydrogenation and dehydrogenation reactions are complete, the percentage of residual BT is low, hence indicating substantial degradation of the LOHC compound. Conversely, when the hydrogenation and dehydrogenation reactions are partial, the LOHC compound is markedly less degraded.

1-11. (canceled)

12. A process for producing hydrogen by partial dehydrogenation of an organic liquid, said process comprising:
a step of supplying at least one organic liquid having a Degree of Hydrogenation DHₚₗᵤₛ,
a step of partially dehydrogenating said liquid,
a step of recovering firstly gaseous hydrogen and secondly said organic liquid having a Degree of Hydrogenation DHₘᵢₙᵤₛ,
the ratio DHₚₗᵤₛ/DHₘᵢₙᵤₛ being between 1 and 25, endpoints excluded.

13. The process as claimed in claim 12, wherein the partial dehydrogenation step is carried out by implementing one or more of the following means, individually or in a combination of two or more thereof:
blocking of the reaction before a 100% dehydrogenation yield is obtained,
reaction temperature lower than the temperature commonly used for the dehydrogenation reaction,
reaction pressure lower than the pressure commonly used for the dehydrogenation reaction,
low-selectivity dehydrogenation catalyst, and
any other means for regulating the dehydrogenation reaction kinetics.

14. The process as claimed in claim 12, wherein the organic liquid is liquid at ambient temperature and pressure.

15. The process as claimed in claim 12, wherein the organic liquid is a mixture of two or more organic liquids which may have identical or different Degrees of Hydrogenation.

16. The process as claimed in claim 12, wherein the organic liquid possesses at least one aromatic ring, which is optionally partially dehydrogenated.

17. The process as claimed in claim 12, wherein the organic liquid corresponds to the general formula (1):
(A−X)ₙ−B (1)
in which:
A and B, which are identical or different, represent, independently of one another, an aromatic ring optionally partially dehydrogenated and optionally substituted by one or more saturated or partially or completely unsaturated hydrocarbon radicals comprising from 1 to 20 carbon atoms,
X represents a spacer group, selected from the group consisting of a single bond, an oxygen atom, a sulfur atom, the divalent radical —(CRR′)ₘ—, the divalent radical >C═CRR′, and the divalent radical —NR″—,
R and R′, which are identical or different, are selected, independently of one another, from hydrogen and a saturated or partially or completely unsaturated hydrocarbon radical comprising from 1 to 6 carbon atoms,
R″ represents a saturated or partially or completely unsaturated hydrocarbon radical comprising from 1 to 6 carbon atoms,
m represents an integer of between 1 and 4, endpoints included, and
n can be equal to 0 or represents an integer equal to 1, 2 or 3, with the restriction that, when n is equal to 0, B is substituted by one or more hydrocarbon radicals, as defined above.

18. The process as claimed in claim 12, wherein the organic liquid is selected from the group consisting of benzyltoluene (BT), dibenzyltoluene (DBT), their partially dehydrogenated homologs, and mixtures thereof in any proportions.

19. The process as claimed in claim 12, wherein the organic liquid has a Degree of Hydrogenation DHₚₗᵤₛ conforming to the inequation 0.6≤DHₚₗᵤₛ<1.

20. The process as claimed in claim 12, wherein the organic liquid has a Degree of Hydrogenation DHₘᵢₙᵤₛ conforming to the inequation 0<DHₘᵢₙᵤₛ≤0.6.

21. A hydrogenation/dehydrogenation cycle comprising at least the process as claimed in claim 12 for producing hydrogen by partial dehydrogenation of an organic liquid and at least one hydrogenation reaction of said organic liquid.

22. The cycle as claimed in claim 21, comprising one or more dehydrogenation processes including at least one which is a process of partial dehydrogenation as claimed in claim 12, prior to and/or consecutively with one or more hydrogenation reactions of an organic liquid capable of storing, transporting and releasing hydrogen.

23. The process of claim 12, wherein the ratio DHₚₗᵤₛ/DHₘᵢₙᵤₛ is between 1.1 and 20, endpoints included.
